(19) United States
(12) Patent Application Publication
(10) Pub. No.: US 2012/0013812 A1
(43) Pub. Date: Jan. 19, 2012

(54) Systems And Methods For Reducing Speckle In Laser Projected Images

(76) Inventor: Jacques Gollier, Painted Post, NY (US)

(21) Appl. No.: 12/835,191

(22) Filed: Jul. 13, 2010

(51) Int. Cl. G02B 27/48; G03B 21/28; H04N 9/31; G02B 26/12

(52) U.S. Cl. 348/744; 353/122; 359/216.1; 353/101; 353/98; 353/121; 348/E09.025

(57) ABSTRACT

A laser projection system includes a light source, a speckle reduction adjustable optical component and a scanning adjustable optical component. The light source includes at least one laser configured to emit an output beam. The speckle reduction adjustable optical component rotates about a speckle reduction axis. The scanning adjustable optical component rotates about two axes. The laser projection system is programmed to generate a scanned laser image on the projection surface by operating the laser for optical emission of encoded image data and controlling the scanning adjustable optical component to rotate about the two axes to scan the output beam in first and second directions. The laser projection system is also programmed to rotate the speckle reduction adjustable optical component and the scanning adjustable optical component such that the output beam illuminates common portions of successive image frames at a different angle of incidence on the projection surface.

### BACKGROUND

1. Field

Embodiments of the present disclosure relate to laser projection systems and, more specifically, to laser projection systems that reduce the appearance of speckle visible in a scanned laser image.

2. Technical Background

Speckle may result whenever a coherent light source is used to illuminate a rough surface, for example, a screen, wall, or any other object that produces a diffused reflection or transmission. Particularly, a multitude of small areas of the screen or other reflecting objects scatter light into a multitude of diffracted beams with different points of origination and different propagation directions. Speckle causes high spatial frequency noise in the projected image. At an observation point, for example in the eyes of an observer or at the sensor of a camera, these beams interfere constructively to form a bright spot, or destructively to form a dark spot, producing a random granular intensity pattern known as speckle. Speckle may be characterized by grain size and contrast, usually defined as a ratio of standard deviation to mean light intensity in the observation plane. For a large enough illuminated area and a small enough individual scattering point size, the speckle will be “fully developed,” with a brightness standard deviation of 100% if the diffuser is not depolarizing light and of about 71% when the diffuser is depolarizing light. If an image is formed on the screen using a coherent light source such as laser beams, such granular structure will represent noise or a serious degradation of the image quality. This noise presents a significant problem, particularly when the projector is used to display high spatial frequency content, such as text.

A general concept of minimizing speckle contrast in an image consists of projecting an intermediate scanned laser image over a small sized diffusing surface, and using projection optics to project that intermediate scanned laser image toward the final projection surface. By rapidly moving the diffuser, the phase of the electric field is scrambled over time, which results in changing the perceived speckle pattern. If the diffuser is moving or vibrating fast enough, the perceived speckle pattern changes at high frequencies and are averaged in time by the eye. To reduce speckle efficiently, multiple speckle frames need to be created over the integration time of the eye, which is typically in the order of 50 Hz.

Although rapidly moving the diffuser provides speckle reduction, it requires expensive and complicated mechanisms to move the phase mask laterally at a relatively high speed. Further, a moving diffuser requires the use of auto-focus mechanisms as well as lenses possessing a high numerical aperture and a high field of view, which adds significant complexity and cost to the system. Therefore, the use of a moving diffuser eliminates an infinite depth of focus feature for the laser projection system implementing such a moving diffuser.

### BRIEF SUMMARY

In one embodiment, a laser projection system includes a light source, a speckle reduction adjustable optical component and a scanning adjustable optical component. The light source includes at least one laser configured to emit an output beam. The speckle reduction adjustable optical component is operable to rotate about at least one speckle reduction axis. The scanning adjustable optical component is operable to rotate about at least two axes. The laser projection system is programmed to generate at least a portion of a scanned laser image having a plurality of successive frames on the projection surface by operating the laser for optical emission of encoded image data and controlling the scanning adjustable optical component to rotate about the two axes to scan the output beam in first and second directions on a projection surface. The laser projection system is also programmed to rotate the speckle reduction adjustable optical component about the speckle reduction axis and the scanning adjustable optical component about at least one of the two axes such that the output beam illuminates common portions of successive image frames at a different angle of incidence on the projection surface at a speckle reduction frequency.

In another embodiment, a laser projection system includes a light source, a speckle reduction adjustable optical component, a scanning adjustable optical component, a first focusing optical component and a second focusing optical component. The light source includes at least one laser configured to emit an output beam. The first focusing component focuses the output beam proximate to the speckle reduction adjustable optical component. The speckle reduction adjustable optical component is positioned in an optical path of the output beam such that the output beam is reflected in a direction toward the scanning adjustable optical component. The second focusing optical component is positioned within the optical path of the output beam reflected by the speckle reduction adjustable optical component and is operable to re-image the output beam focused on the speckle reduction adjustable optical component onto the projection surface. The scanning adjustable optical component is positioned in an optical path of the output beam reflected by the speckle reduction adjustable optical component such that the output beam is reflected in a direction toward a projection surface. The laser projection system is programmed to generate at least a portion of a scanned laser image having a plurality of successive frames on the projection surface by operating the laser for optical emission of encoded image data and controlling the scanning adjustable optical component to rotate about the two axes to scan the output beam in first and second directions on a projection surface, rotate the speckle reduction adjustable optical component about the speckle reduction axis at a speckle reduction frequency to shift a position of the output beam on the scanning adjustable optical component, the speckle reduction frequency greater than or equal to an image frame rate, and adjust a focus of the second focusing optical component in accordance with a projection distance such that the output beam illuminates common portions of successive image frames at a different angle of incidence on the projection surface at the speckle reduction frequency.

In yet another embodiment, a method of operating a laser projection system including a light source having at least one laser, a speckle reduction adjustable optical component and a scanning adjustable optical component includes generating at least a portion of a scanned laser image on a projection surface by operating the laser for optical emission of encoded image data and controlling the scanning adjustable optical component to rotate about at least two axes to scan the output beam across a plurality of image pixels forming an image frame. The method further includes rotating the speckle reduction adjustable optical component about a speckle reduction axis at a speckle reduction frequency to shift a position of the output beam upon the scanning adjustable optical component and illuminate common portions of successive image frames at a different angle of incidence on the projection surface as the plurality of image pixels are scanned across the projection surface.

### BRIEF DESCRIPTION OF THE SEVERAL VIEWS OF THE DRAWINGS

The following detailed description of specific embodiments of the present disclosure can be best understood when read in conjunction with the following drawings, where like structure is indicated with like reference numerals and in which:

FIG. 1a is a schematic illustration of an exemplary laser projection system according to one or more embodiments;

FIG. 1b is a schematic illustration of an exemplary laser projection system according to one or more embodiments;

FIG. 2 is a schematic illustration of an exemplary laser projection system comprising a scanning adjustable optical component having a plurality of facets according to one or more embodiments;

FIG. 3a is a schematic illustration of an exemplary laser projection system comprising a focusing optical component and operated in a non-speckle reduction mode according to one or more embodiments; and

FIG. 3b is a schematic illustration of an exemplary laser projection system comprising a focusing optical component and operated in a speckle reduction mode according to one or more embodiments.

### DETAILED DESCRIPTION

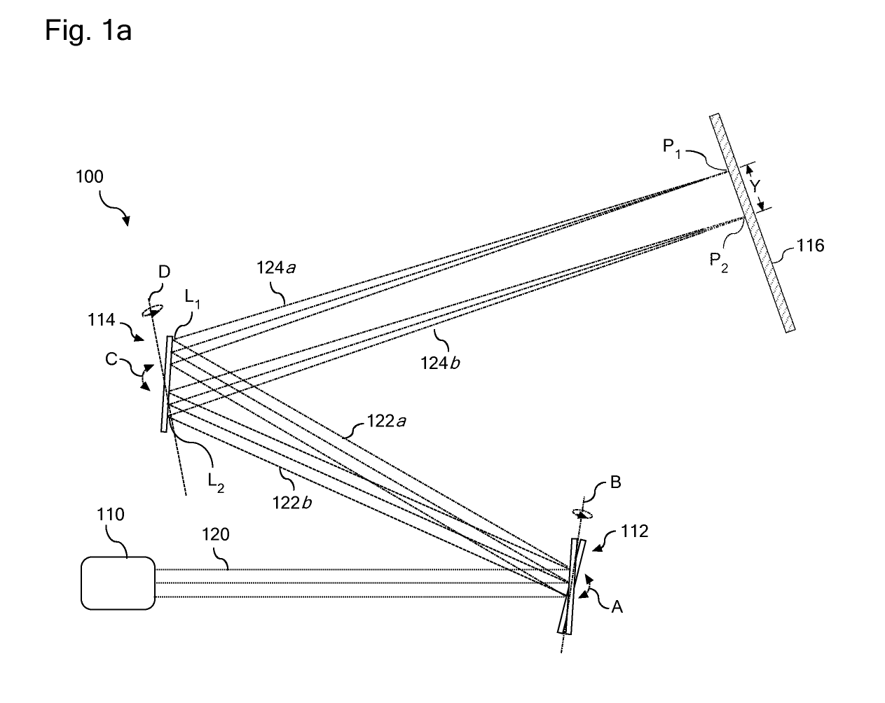

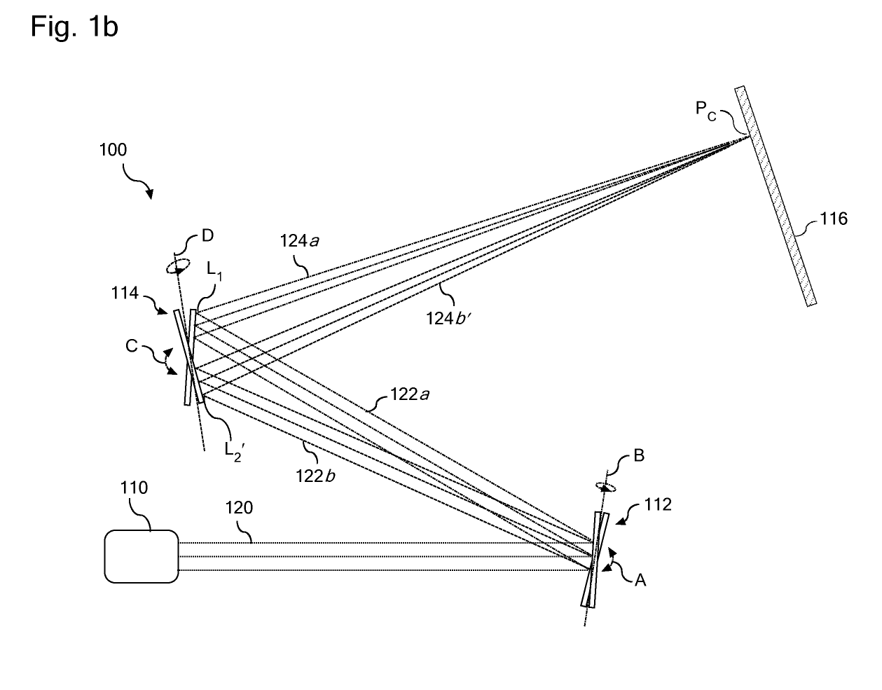

Particular embodiments of the present disclosure may be described in the context of a laser projection system that scans an output beam across a projection surface to generate a two dimensional image. However, embodiments may be implemented in not only laser projection systems, but other optical systems utilizing coherent light sources where the reduction of speckle is desired. Generally, as illustrated in FIGS. 1a-3b, the appearance of speckle in the scanned laser image may be reduced by changing the angle of incidence of the scanned output beam as it illuminates portions of an image frame on a projection surface. The angle of incidence of the scanned output beam may be changed at a speckle reduction frequency by changing the position of the output beam on an adjustable optical component that directs the output beam toward the projection surface. By changing the angle of incidence of the scanned output beam over the projection surface at the speckle reduction frequency, different speckle patterns may be created because the light hits the projection surface at different angles. The human eye or sensor averages the different speckle patterns over time and the appearance of speckle may be thereby reduced. Embodiments change the angle of incidence of the output beam upon the projection surface by projecting the scanned laser image from different angles at a speckle reduction frequency, such as at a frame-per-frame basis or at an every other frame basis, for example.

Referring now to FIG. 1a a schematic illustration of one embodiment of a laser projection system 100 is illustrated. The exemplary laser projection system 100 is configured as a scanning laser projection system that is programmed to two-dimensionally scan an output beam 120 generated by a light source 110 to create a two-dimensional image at a given projection surface 116, such as a wall or a projector screen, for example. The laser projection system 100 may be used to display static images (e.g., text), moving images (e.g., video), or both. The system may be compact such that it may be incorporated into a relatively small device, such as a hand-held projector, cell phone, personal data assistant, notebook computer or other similar devices.

The light source 110 may comprise one or more lasers that are operable to emit coherent beams at different wavelengths. For example, the light source 110 may comprise three lasers capable of emitting beams of red, blue and green wavelengths, respectively. According to some embodiments, the output beam 120 consists of collimated red, green and blue beams. Other embodiments may utilize a light source 110 that emits more or fewer collimated laser beams, and/or beams at wavelengths other than red, blue or green. For example, output beam 120 may be a single output beam having a wavelength in the green spectral range.

The light source 110 may comprise one or more single-wavelength lasers, such as distributed feedback (DFB) lasers, distributed Bragg reflector (DBR) lasers, vertical cavity surface-emitting lasers (VCSEL), diode pumped solid state lasers (DPSS), native green lasers, vertical external cavity surface-emitting lasers (VECSEL) or Fabry-Perot lasers, for example. Additionally, to generate a green beam, the light source 110 of some embodiments may also comprise a wavelength conversion device (not shown) such as a second harmonic generating (SHG) crystal or a higher harmonic generating crystal to frequency-double a laser beam having a native wavelength in the infrared band. For example, a SHG crystal, such as an MgO-doped periodically poled lithium niobate (PPLN) crystal, may be used to generate green light by converting the wavelength of a 1060 nm DBR or DFB laser to 530 nm. The light source 110 may also comprise lasers other than single wavelength lasers, such as lasers capable of emission of multiple wavelengths. In other embodiments, the light source 110 may comprise a laser capable of emitting a native green laser without the use of a wavelength conversion device.

The laser projection system 100 may be programmed to perform many of the control functions disclosed herein. The system 100 may be programmed in numerous ways, including conventional or yet-to-be-developed programming methods. Methods of programming the system 100 discussed herein are not intended to limit the embodiments to any specific way of programming.

In some embodiments, the laser projection system 100 may include one or more system controllers (not shown), such as microcontrollers, for example, that are programmed to control the light source 110 to generate a single or multi-color image data stream. The system controller, along with image projection software and associated electronics known in the art, may provide the light source with one or more image data signals (e.g., laser drive currents) that carry image data. To create the desired image, the light source 110 may then emit the encoded image data in the form of gain or intensity variations of the output beam 120. However, some embodiments may utilize other controller or programming means to generate the scanned laser image.

Positioned within an optical path of the output beam 120 are a speckle reduction adjustable optical component 112 and a scanning adjustable optical component 114. The speckle reduction and scanning adjustable optical components 112, 114 may comprise one or more controllable and movable micro-opto-electromechanical systems (MOEMS) or micro-electro-mechanical systems (MEMS). It is also contemplated that the MOEMS or MEMS be operatively coupled to a mirror or a prism that is configured to redirect the output beam accordingly.

The output beam 120 emitted by the light source 110 is directed toward the speckle reduction adjustable optical component 112. The speckle reduction adjustable optical component 112 may be controlled to rotate in at least one direction. In one embodiment, the speckle reduction adjustable optical component 112 may rotate about two axes: first speckle reduction axis A and second speckle reduction axis B. The speckle reduction adjustable optical component 112 is positioned and angled to redirect the output beam (e.g., first redirected output beam 122a) toward the scanning adjustable optical component 114. The scanning adjustable optical component 114 is controlled to rotate in at least two directions about slow axis C and fast axis D to scan the output beam (e.g., first scanned output beam 124a) over the projection surface 116 and, therefore, generate an image comprising a plurality of pixels arranged in rows and columns on the projection surface 116. The phrases “fast axis” and “slow axis” are used because generally the raster scanning of pixels to form a two-dimensional image is faster in one direction than in the second direction. It should be understood that the phrases “fast axis” and “slow axis” are not meant to limit the embodiments described herein to any speed of rotation or movement. The scanning adjustable optical component 114 may be a MEMS deflection system capable large angular deflections in the two directions corresponding to the fast axis D and the slow axis C, and may used to scan the output beam at the projection surface 116 to generate an image at an image refresh rate (e.g., 60 Hz). Although the scanning adjustable optical component 114 is described and illustrated herein as a single adjustable optical component capable of angular deflections in two directions (i.e., a two-dimensional MEMS mirror), it is to be understood that the scanning adjustable optical component 114 may have other configurations. For example, the scanning adjustable optical component 114 may comprise two one-dimensional MEMS-actuated mirrors that cooperate to scan the output beam in two directions.

Generally, the speckle reduction and scanning adjustable optical components 112, 114 cooperate to scan a plurality of image pixels across the projection surface 116 to form a plurality of successive image frames that collectively form a scanned laser image. To generate a two-dimensional image, the speckle reduction adjustable optical component 112 directs redirected output beam 122a toward the scanning adjustable optical component 114. The scanning adjustable optical component 114 may be controlled to rotate about the fast axis D so that the scanned output beam 124a is shifted in a horizontal direction as it is reflected toward the projection surface 116 (e.g., redirected beam 124a) to generate the horizontal rows of pixels of the projected image frame on the projection surface 116. The scanning adjustable optical component 114 may be controlled to rotate about the slow axis C so that the output beam is shifted in a vertical direction as it is reflected toward the projection surface 116 (e.g., redirected beam 124a). The rotation of the scanning adjustable optical component 114 about the slow axis C may generate the columns of pixels of the projected image frame on the projection surface 116.

The output beam 120 is directed to toward the speckle reduction adjustable optical component 112 that reflects a redirected output beam 122a that corresponds to a first image frame of a scanned laser image on the projection surface 116. Redirected output beam 122a is directed toward the scanning adjustable optical component 114 such that it is incident on the scanning adjustable optical component 114 at location L₁. The scanning adjustable optical component 114 redirects the scanned output beam 124a toward the projection surface 116 so that the scanned output beam 124a is incident on the projection surface 116 at portion P₁ of a first image frame.

The speckle reduction adjustable optical component 112 may also rotate about one or more speckle reduction axes (e.g., first speckle reduction axis A and/or second speckle reduction axis B) at a speckle reduction frequency to change the position of the redirected output beam on the scanning adjustable optical component 114 during a speckle reduction operational mode. Two positions of the speckle reduction and scanning adjustable optical components 112, 114 are illustrated in FIG. 1a at two moments in time. Therefore, the redirected output beam 122a and the scanned output beam 124b occur at a different time and produce a different image frame than the redirected output beam 122b and the scanned output beam 124b. Additionally, it should be understood that the figures are not drawn to scale, and the angles of the redirected and scanned output beams depicted in each of the figures are exaggerated for illustrative purposes. The speckle reduction frequency may be equal to the image frame rate, for example. In this example, the speckle reduction adjustable optical component 112 will remain at a fixed position as the second adjustable optical 114 scans an image frame (e.g., a first image frame). It is noted that during a non-speckle reduction operational mode, the speckle reduction adjustable optical component 112 may remain fixed for all image frames.

After completion of the scanned image frame, the speckle reduction adjustable optical component 112 may be controlled to incrementally rotate about the first speckle reduction axis A as illustrated in FIG. 1b. The speckle reduction adjustable optical component 112 may also rotate about the second speckle reduction axis B, or both speckle reduction axes at the same time. FIG. 1b illustrates the speckle reduction adjustable optical component 112 rotating from a first position to a second position about the first speckle reduction axis A. The second position causes the output beam 120 to be directed toward the scanning adjustable optical component 114 as redirected output beam 122b. Redirected output beam 122b is incident upon the scanning adjustable optical component 114 at location L₂. Therefore, the speckle reduction adjustable optical component 112 rotates about the first speckle reduction axis A to shift a position of the redirected output beam upon the scanning adjustable optical component 114. The scanning adjustable optical component 114 then directs scanned output beam 124b toward the projection surface 116 such that the scanned output beam 124b is incident the projection surface 116 at location P₂ to form a subsequent image frame (e.g., a second image frame). As stated above, the figures are not to scale and for illustrative purposes only.

More specifically, when a frame “k” is scanned by the scanning adjustable optical component 114, the speckle reduction adjustable optical component 112 stays at a fixed angle and position. At the end of the frame (i.e., the scanning adjustable optical component 114 has completed raster scanning in both directions), the one or more lasers of the light source are switched OFF for a certain period of time (i.e., the end of frame duration) to allow the scanning adjustable optical component 114 return to a position at the beginning of the next frame “k+1.” During the end of frame duration, the speckle reduction adjustable optical component 112 is moved to a different position so that the redirected output beam 122b is incident on the scanning adjustable optical component 114 at a different position.

By rotating the speckle reduction adjustable optical component 112, the position of the redirected output beam over the scanning adjustable optical component 114 changes. Since the light is projected from a different position on the scanning adjustable optical component 114, the incidence angle over the screen is changed, thereby resulting in the creation of a different speckle pattern. By rotating the speckle reduction adjustable optical component 112 in at least one direction, there are multiple combinations of the speckle reduction and scanning adjustable optical components 112, 114 that can produce the same pixel on the projection surface 116 illuminated at different angles. Only two combinations are shown in FIG. 1a for ease of illustration.

Because the rotation of the speckle reduction adjustable optical component 112 about the first speckle reduction axis B changes the location of the redirected output beam 122, the position of the scanned output beam 124 on the projection surface 116 may also change in a Y direction (e.g., a vertical direction on the projection surface 116), as depicted in FIG. 1a. If the speckle reduction adjustable optical component 112 rotates in the second speckle reduction axis B, the position of the scanned output beam 124 on the projection surface 116 may change in a X direction (e.g., a horizontal direction on the projection surface 116). The location of the scanned output beam in the Y direction may be approximated by considering the rotation of the speckle reduction adjustable optical component about the first speckle reduction axis A and the rotation of the scanning adjustable optical component about the slow axis C. Because the first speckle reduction axis A and the slow axis C are in the same direction (i.e., into/out of the page of FIG. 1), these two axes will be referred to collectively as the X direction for ease of discussion. The location of the scanned output beam on the projection surface may be approximated by:

P=(D1+D2)*tan(2θx₁+D2*tan(2θx₂), Eq. 1,

where:

P is the location of the scanned output beam on the projection surface in the Y direction,

D1 is the distance between the speckle reduction adjustable optical component and the scanning adjustable optical component;

D2 is the distance between the scanning adjustable optical component and the projection surface,

θx₁ is the angle of the first adjustable component around the X direction, and

θx₂ is the angle of the second adjustable component around the X direction.

Because the rotation of the speckle reduction adjustable optical component 112 about the first speckle reduction axis A correspondingly shifts the position of the scanned output beam 124 on the projection surface, thereby causing a relative image shift, common portions may not be illuminated on a frame-per-frame basis and the scanned laser image distortion may occur. As used herein, the phrase “common portion” refers to the location on the projection surface that correspond to a pixel of the image frames. When scanned output beams are not incident on the projection surface at common portions, a relative image shift may occur. The data corresponding to scanned output beam 124a is intended to paint a similar pixel of an image frame as the data for scanned output beam 124b, yet the two scanned output beams are not incident at the same portion (i.e., scanned output beam 124a is incident at portion P₁ scanned output beam 124b is incident on the projection surface at projection surface 116 at portion P₂). In other words, output beams 124a and 124b do not illuminate common portions. As a result, the scanned laser image may move at the speckle reduction frequency and appear blurry to an observer. To ensure that the image appears stable to the observer, the laser projection system should be programmed to compensate for the relative image shift.

In one embodiment, an image compensation algorithm may be applied to the light source 110 in accordance with a calculated position of the output beam on the projection surface for a particular distance of the laser projection system from the projection surface. The image compensation algorithm may alter the data provided to the light source 110. The optical data is altered such that the portion on the projection surface receives the correct data for the intended pixel.

As an example and not a limitation, if a pixel P1 is illuminated by a beam spot on the projection surface produced by the scanned output beam B1 during a first frame, but is illuminated by a different beam spot B5 during the second frame as a result from the rotation of the speckle reduction adjustable optical component, the image correction algorithm may change the image data provided to the light source such that beam spot B5 corresponds to pixel P1 rather than pixel P5 during the second frame. Because the algorithm may take into account the distance of the laser projection system to the projection surface and calculate the individual frames for any particular projector distance D, the system does not require focus mechanisms, although such focus mechanisms may be utilized in some embodiments if desired. When the projection distance changes, the projector may be programmed to adjust the projector distance parameter D in the image compensation algorithm used for the image compensation. For example, a user may program the projector distance D into the laser projector system, or the laser projector system may detect the projector distance D and adjust the parameter accordingly. In this manner, the image may appear stable to an observer.

Referring now to FIG. 1b, compensation for the relative image shift may also be achieved by introducing a compensation angle on the rotation of the scanning adjustable optical component 114. Rather than keeping the scanning angles of the scanning adjustable optical component 114 equal frame per frame, the angular deflection of the speckle reduction adjustable optical component 112 may be compensated by an angular deflection of the scanning adjustable optical component 114. The scanning adjustable optical component 114 may be rotated about the slow axis C (i.e., X direction) by a compensation angle in addition to the angle necessary to produce the two-dimensional scanned image so that the scanned output beam 124 reaches common portions on the projection surface 116.

In the embodiment illustrated in FIG. 1b, the speckle reduction adjustable optical component 112 reflects redirected output beam 122a such that it is incident on the scanning adjustable optical component 114 at location L₁, as describe above with reference to FIG. 1a. The scanning adjustable optical component 114 the directs scanned output beam 124a such that it is incident on the projection surface 116 at common portion P_{c}. After the scanning adjustable optical component 114 completes the generation of a scanned image frame, the speckle reduction adjustable optical component 112 may be rotated about the first speckle reduction axis A (and/or second speckle reduction axis B) to produce redirected output beam 122b. The scanning adjustable optical component 114 is rotated about the slow axis C such that the redirected output beam 122b is incident on the scanning adjustable optical component 114 at location L₂′ for the image frame subsequent to the frame produced by output beam 122a. The angular deflection of the scanning adjustable optical component 114 causes the reflected scanned output beam 124b′ to be incident on the projection surface 116 at common portion P_{c}, which is the same location of incidence as scanned output beam 124a. In this manner, the speckle reduction and scanning adjustable optical components 112, 114 may cooperate to illuminate common portions of the scanned laser image on the projection surface at varying angles of incidence at the speckle reduction frequency, which may be at an image frame rate, for example.

The angular deflection to compensate for the rotation of the speckle reduction adjustable optical component about the first speckle reduction axis A may be approximated by:

$$θ {x}_{2} = 0.5 arc tan [ ( L - ( D 1 + D 2 ) * \frac{tan ( 2 θ {x}_{1}}{D 2} ] , \qquad Eq . 2.$$

It is noted that Equations 1 and 2 above are approximations because they do not consider scanning along the fast axis D. Scanning along the fast axis D may introduce non-linear distortion variations from frame to frame. This distortion may require additional corrections which are a function of the parameters of the scanning system such as distance and angles between the speckle reduction and scanning adjustable optical components as well as the amplitude of the deflections provided. As described above with respect to the image compensation algorithm, the angular deflection to compensate for the rotation of the speckle reduction adjustable optical component depends on the projection distance D. Therefore, a user may program or adjust the laser projector system to correctly set the projector distance parameter D so that accurate angular deflections may be calculated.

The rotation of the speckle reduction adjustable optical component should provide a minimum angle of deflection for effective speckle reduction. It may be shown that the frame to frame change in illumination angle is defined, in first approximation, by:

Dθ=(D1/D2)tan(2θx₁), Eq. 3,

where Dθ is the variation of the illumination angle θx₁ generated by the rotation of the speckle reduction adjustable optical component about the first speckle reduction axis A. To create an effective illumination angle, the value of Dθ should be large enough to create uncorrelated speckle patterns. The present inventor has recognized that speckle patterns are nearly uncorrelated if the variation in the illumination angle Dθ is in the order of half the pupil angular extend. The pupil angular extend for the human eye may be estimated as approximately 5 mm. Therefore, considering an example of an observer 1 meter away from a projection surface and a pupil diameter of 5 mm, Dθ should be in the order of 2.5 mRd to obtain nearly uncorrelated speckle patterns.

Additionally, the present inventor has recognized that the speckle correlation function may also depend on the nature of the projection surface itself. For example, the speckle correlation function for a glossy projection surface (e.g., a glossy poster card board) may be different than the speckle correlation function for a piece of printer paper, which may provide bulk scattering of the scanned output beam. Experimentation for different projection surfaces indicates that Dθ may be within the range of about 1.5 mRd to about 2.5 mRd for creating effective uncorrelated speckle patterns.

As an example and not a limitation, considering Dθ in the order of about 2 mRd, a distance between the speckle reduction and scanning adjustable optical components (D1) in the order of about 10 mm and a distance of the laser projection system to the projection screen (D2), the minimum deflection 2θx₁ should be in the order of about 11 degrees. Therefore, assuming that five independent speckle patterns are desired on a frame-per-frame bases, the total vertical deflection of the speckle reduction adjustable optical component should be about 44 degrees and the size of the scanning adjustable optical component along a vertical direction should be in the order of about 10 mm, for example.

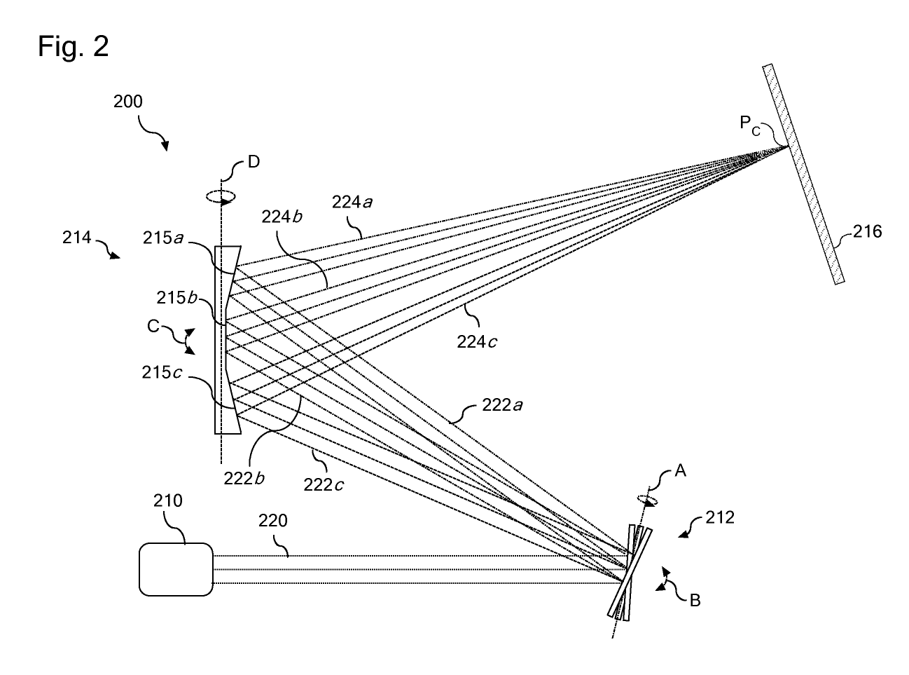

The rotation amplitude of the scanning adjustable optical component 114 may be large because the scanning adjustable optical component 114 provides 1) the deflection to produce the image in the slow axis direction and 2) the deflection needed to compensate from the rotation of the speckle reduction adjustable optical component 112 in the speckle reduction axis. FIG. 2 illustrates an embodiment that may ease the rotation amplitude burden on the scanning adjustable optical component 114. Like the embodiment illustrated in FIGS. 1a and 1b, the laser projection system 200 illustrated in FIG. 2 comprises a light source 210 emitting an output beam 220, a speckle reduction adjustable optical component 212 and a scanning adjustable optical component 214. The speckle reduction adjustable optical component 212 may be controlled to rotate about a first speckle reduction axis A and a second speckle reduction axis B, and the scanning adjustable optical component 214 may be controlled to rotate about a slow axis C and fast axis D, as described above. FIG. 2 illustrates three redirected output beams 222a, 222b and 222c (and three scanned output beams 224a, 224b and 224c) produced by the rotation of the speckle reduction adjustable optical component 212 about the first speckle reduction axis A. However, it should be understood that more than three redirected output beams may be produced.

The scanning adjustable optical component 214 comprises a facetted mirror having three facets 215a, 215b and 215c that correspond to the redirected output beams 222a, 222b and 222c, respectively. The number of facets corresponds to the number of desired uncorrelated speckle patterns. The angles of each facet are such that the angular deflections produced by the speckle reduction adjustable optical component 212 are at least partially compensated and each scanned output beam 224a, 224b and 224c illuminate common portions on the projection surface (e.g., common portion P_{c}). The facets may be achieved by texturing the surface of the MEMS actuated scanning adjustable optical component 214.

The speckle reduction adjustable optical component 212 may be rotated about the first speckle reduction axis A (and/or second speckle reduction axis B) to direct redirected output beam 222a toward the scanning adjustable optical component 214 at a location on facet 215a. The angle of facet 215a and orientation of the scanning adjustable optical component 214 are such that a scanned beam 224a is incident on the projection surface 216 at common portion P_{c}. The speckle reduction adjustable optical component 214 may then be rotated about speckle reduction axis B to direct redirected output beam 222b toward facet 215b. The angle of facet 215b and orientation of the scanning adjustable optical component 214 provide that scanned beam 224b is also incident on the projection surface 216 at common portion P_{c} for the image frame following the image frame produced by scanned output beam 224a. The speckle reduction adjustable optical component 212 may be rotated again about the speckle reduction axis B to produce a third redirected output beam 222c that is incident on the scanning adjustable optical component 214 at a location on facet 215c. Like the other facets, facet 215c is angled such that scanned output beam 224c is similarly incident on the projection surface 216 at common portion P_{c}.

In this manner, the angled facets of the facetted mirror may aid in providing a partial compensation for the rotation of the speckle reduction adjustable optical component 212 about the speckle reduction axis B while reducing the rotation amplitude of the scanning adjustable optical component 214 to yield a stable scanned laser image having reduced speckle appearance. Image correction algorithms and angular deflection control of the scanning adjustable optical component as described above may also be applied in conjunction with this embodiment to compensate for any relative image shift due to the rotation of the speckle reduction adjustable optical component 212 about either the fast axis A or the speckle reduction axis B, or any image shift not fully compensated by the facetted mirror.

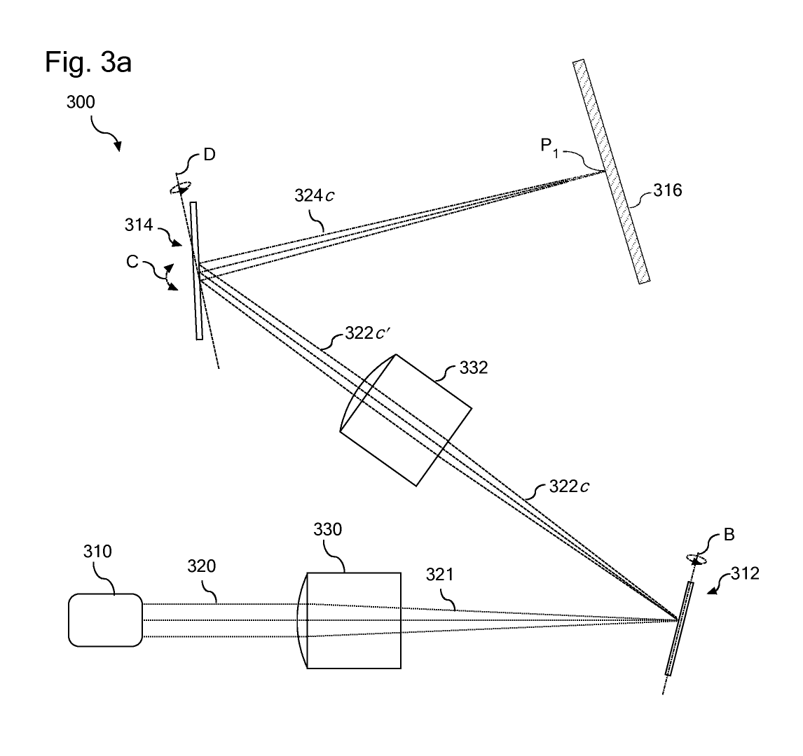

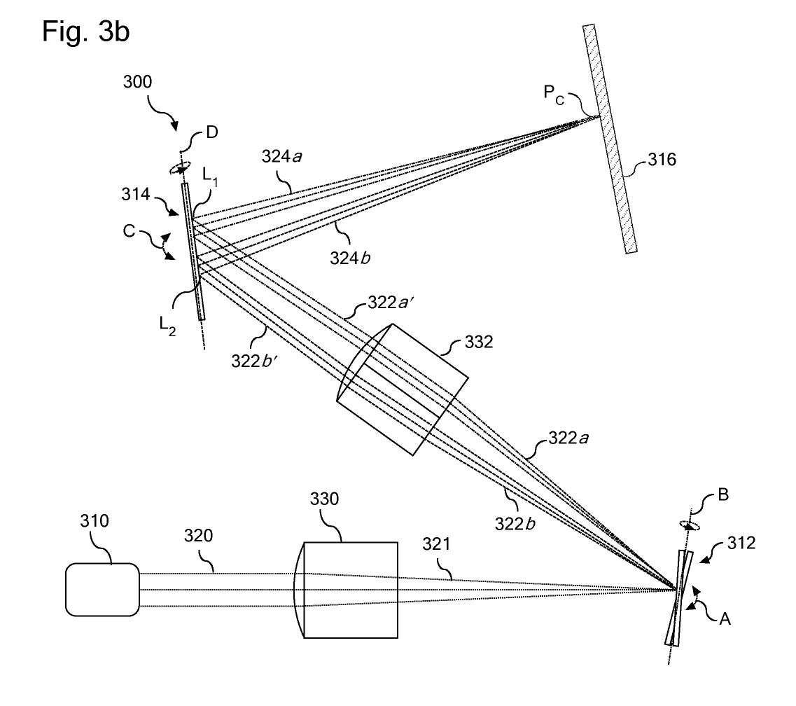

FIGS. 3a and 3b illustrate another embodiment of a laser projection system 300 that provides for speckle reduction. The system 300 generally comprises a light source 310 emitting an output beam 320, a speckle reduction adjustable optical component 312, a focusing optical component 332, and a scanning adjustable optical component 314. The speckle reduction and scanning adjustable optical components 312, 314 may operate in a similar manner as the speckle reduction and scanning adjustable optical components described above. The laser projection system 300 may also comprise an initial focusing optical component 330 that focuses the output beam 320 onto the speckle reduction adjustable optical component 312 (focused output beam 321). The focused point at location L₀ on the second adjustable component 312 is then reimaged through the optical component 332 on the diffusing surface 316 (screen) so that the light converges at a single point P1. The embodiments illustrated in FIGS. 1a, 1b and 2 may similarly utilize an initial focusing optical component.

In a non-speckle reduction mode, infinite depth of focus of the laser projection system 300 may be maintained as illustrated in FIG. 3a. When operating in the non-speckling reduction mode, the speckle reduction adjustable optical component 312 is operated in an OFF mode such that it does not rotate about the speckle reduction axis B. Therefore, the speckle reduction adjustable optical component 312 directs redirected beam 322c such that it passes through the focusing optical component 332 and is centered on the scanning adjustable optical component 314 at location L₀ as focused redirected output beam 322′. The scanning adjustable optical component 314 directs the scanned output beam 324c toward the projection surface 316 at portion P₁. The speckle reduction adjustable optical component 312 may rotate about the fast axis A and the scanning adjustable optical component 314 may rotate about the slow axis C to produce a two-dimensionally scanned laser image as described above. The non-speckle reduction mode may be useful for applications in which infinite depth of focus is desired and/or the laser projection system 300 is producing images with minimal spatial frequency content (e.g., videos).

The laser projection system 300 may also operate in a speckle reduction mode as illustrated in FIG. 3b. In this mode of operation, the speckle reduction adjustable optical component 312 is operated in an ON mode such that it produces angular deflection as described above (i.e., rotates about speckle reduction axis B to produce redirected beams output beams 322a and 322b). The focusing optical component 332 has a default focal length that corresponds with a default projection distance (i.e., a default distance of the laser projection system to a projection surface). The default focal length of the focusing optical component 332 is such that the scanned output beams 324a and 324b converge and are incident on the projection surface 316 at common portion P_{c}. As illustrated in FIG. 3b, redirected output beam 322a passes through the focusing optical component 332 and is focused such that focused redirected output beam 322a′ is incident on the scanning adjustable optical component 314 at location L₁ and at an angle that causes reflected scanned output beam 324a to be incident on the projection surface 316 at common portion P_{c}. It is again noted that the various output beams are depicted having an exaggerated angle for illustrative purposes.

The first adjusted optical component 312 may be rotated to produce redirected output beam 322b. As shown in FIG. 3b, the focusing optical component 332 is to re-image the beam focused on 312 over the projection surface 316. Redirected output beam 322b is focused by the focusing optical component 332 so that a focused redirected output beam 322b′ strikes the scanning adjustable optical component 314 at location L₂ at an angle of incidence that is different than the angle of incidence of focused redirected output beam 322a′. This different angle of incidence causes the scanned output beam 324b to illuminate common portion P_{c} on the projection surface 316. In this manner, the default focal length of the focusing optical component 332 causes all of the scanned output beams 324 to illuminate common portion P_{c} for each pixel of successive image frames of the scanned laser image.

The focal length or the position along the optical axis of the focusing optical component 332 is adjustable so that the scanned output beams 324 converge at common portions when the laser projection system 300 is operated at a projection distance other than the default projection distance. The focal length of the focusing optical component 332 may become shorter or longer in accordance with the projector distance D. The projector distance D may be detected by the laser projection system 300 or manually entered by a user. The focusing optical component 332 may be configured in a variety of ways to achieve an adjustable focal length. In one embodiment, the focusing optical component 332 may be a plurality of lenses having different focal lengths that may be moved into and out of the optical path of the redirected output beams 322 according to the projection distance. In another embodiment, the focusing optical component 332 may be mechanically moved toward the speckle reduction and scanning adjustable optical components 312, 314 to change the focus. The focusing optical component 332 may also be one or more tunable liquid lenses having variable focal lengths. The image compensation algorithm and angular deflection compensation methods described above may also be utilized for image correction.

It should be understood that by using two adjustable optical components such as speckle reduction adjustable optical component 112 and scanning adjustable optical component 114 rather than a single adjustable optical component, each portion of the projection surface may be illuminated with an infinite combination of angles. Each of these combination is an illumination portion at a different angle resulting in changing of the perceived speckle pattern. The speckle reduction adjustable optical component may be activated on a frame per frame basis to modify the speckle pattern while the second adjustable optical component may be constantly moving to scan the entire image. It should be understood that other approaches may also be applied such as, for instance, reversing the arrangement of the speckle reduction adjustable optical component and the scanning adjustable optical component to modify the speckle pattern.

For the purposes of describing and defining embodiments of the present disclosure it is noted that the term “substantially” is utilized to represent the inherent degree of uncertainty that may be attributed to any quantitative comparison, value, measurement, or other representation.

It is noted that recitations herein of a component of a particular embodiment being “programmed” in a particular way, “configured” or “programmed” to embody a particular property, or function in a particular manner, are structural recitations as opposed to recitations of intended use. More specifically, the references herein to the manner in which a component is “programmed” or “configured” denotes an existing physical condition of the component and, as such, is to be taken as a definite recitation of the structural characteristics of the component.

It is also noted that the use of the phrase “at least one” in describing a particular component or element does not imply that the use of the term “a” in describing other components or elements excludes the use of more than one for the particular component or element. More specifically, although a component may be described using “a,” it is not to be interpreted as limiting the component to only one.

While particular embodiments have been illustrated and described herein, it should be understood that various other changes and modifications may be made without departing from the spirit and scope of the claimed subject matter. More specifically, although some aspects of the embodiments described are identified herein as preferred or particularly advantageous, it is contemplated that the claimed subject matter is not necessarily limited to these preferred aspects.

1. A laser projection system comprising a light source, a speckle reduction adjustable optical component and a scanning adjustable optical component, wherein:
the light source comprises at least one laser configured to emit an output beam;
the speckle reduction adjustable optical component is operable to rotate about at least one speckle reduction axis;
the scanning adjustable optical component is operable to rotate about at least two axes; and
the laser projection system is programmed to:
generate at least a portion of a scanned laser image comprising a plurality of successive frames on a projection surface by operating the laser for optical emission of encoded image data and controlling the scanning adjustable optical component to rotate about the two axes to scan the output beam in first and second directions on the projection surface; and
rotate the speckle reduction adjustable optical component about the speckle reduction axis and the scanning adjustable optical component about at least one of the two axes such that the output beam illuminates common portions of successive image frames at a different angle of incidence on the projection surface at a speckle reduction frequency.

2. The laser projection system as claimed in claim 1 wherein the speckle reduction frequency is greater than or equal to an image frame rate.

3. The laser projection system as claimed in claim 1 wherein the laser projection system is further programmed to compensate for a relative image shift on the projection surface.

4. The laser projection system as claimed in claim 3 wherein the laser projection system is programmed to compensate for the relative image shift by applying an image compensation algorithm to alter the encoded image data in accordance with a distance of the laser projection system from the projection surface.

5. The laser projection system as claimed in claim 3 wherein the laser projection system is programmed to compensate for the relative image shift by rotating the scanning adjustable optical component about one of the at least two axes to shift a position of the output beam upon the projection surface such that the output beam illuminates the same location on the projection surface for common portions of successive image frames.

6. The laser projection system as claimed in claim 3 wherein the scanning adjustable optical component comprises a MEMS-actuated mirror having a plurality of facets.

7. The laser projection system as claimed in claim 6 wherein each facet is angled to reflect the output beam toward the projection surface such that the output beam illuminates the same location on the projection surface for common portions of successive image frames as the speckle reduction adjustable optical component rotates about the speckle reduction axis.

8. The laser projection system as claimed in claim 6 wherein each facet of the MEMS-actuated mirror is angled to provide a compensation for the rotation of the speckle reduction adjustable optical component about the speckle reduction axis.

9. The laser projection system as claimed in claim 1 further comprising a first focusing optical component and a second focusing optical component, wherein:
the first focusing optical component focuses the output beam proximate to the speckle reduction adjustable optical component;
the second focusing optical component is positioned within an optical path of the output beam reflected by the speckle reduction adjustable optical component and is operable to re-image the output beam focused on the speckle reduction adjustable optical component onto the projection surface; and
the laser projection system is further programmed to operate in a speckle reduction mode wherein the speckle reduction adjustable optical component rotates about the speckle reduction axis and a default focal length of the second focusing optical component causes the output beam to illuminate common portions of successive image frames at a different angle of incidence on the projection surface for a default projection distance.

10. The laser projection system as claimed in claim 9 wherein when operating in the speckle reduction mode, the speckle reduction adjustable optical component shifts a location of the output beam on the scanning adjustable optical component and the second focusing optical component focuses the output beam in accordance with a projection distance such that the output beam illuminates common portions of successive image frames.

11. The laser projection system as claimed in claim 10 wherein the second focusing optical component comprises a plurality of lenses.

12. The laser projection system as claimed in claim 11 wherein the laser projection system is operable to move one or more lenses of the plurality of lenses into or out of the optical path of the output beam reflected by the speckle reduction adjustable optical component in accordance with the projection distance.

13. The laser projection system as claimed in claim 10 wherein the second focusing optical component comprises a liquid lens having an adjustable focal length.

14. The laser projection system as claimed in claim 1 wherein the laser projection system is further programmed to operate in a non-speckle reduction mode where the speckle reduction adjustable optical component does not rotate about the speckle reduction axis while the scanned laser image is generated.

15. A laser projection system comprising a light source, a speckle reduction adjustable optical component, a scanning adjustable optical component, a first focusing optical component and a second focusing optical component, wherein:
the light source comprises at least one laser configured to emit an output beam;
the first focusing optical component focuses the output beam proximate to the speckle reduction adjustable optical component;
the speckle reduction adjustable optical component is positioned in an optical path of the output beam such that the output beam is reflected in a direction toward the scanning adjustable optical component;
the second focusing optical component is positioned within the optical path of the output beam reflected by the speckle reduction adjustable optical component and is operable to re-image the output beam focused on the speckle reduction adjustable optical component onto a projection surface;
the scanning adjustable optical component is positioned in the optical path of the output beam reflected by the speckle reduction adjustable optical component such that the output beam is reflected in a direction toward the projection surface;
the laser projection system is programmed to:
generate at least a portion of a scanned laser image comprising a plurality of successive frames on the projection surface by operating the laser for optical emission of encoded image data and controlling the scanning adjustable optical component to rotate about the two axes to scan the output beam in first and second directions on the projection surface; and
rotate the speckle reduction adjustable optical component about the speckle reduction axis at a speckle reduction frequency to shift a position of the output beam on the scanning adjustable optical component, the speckle reduction frequency being greater than or equal to an image frame rate; and
adjust a focus of the second focusing optical component in accordance with a projection distance such that the output beam illuminates common portions of successive image frames at a different angle of incidence on the projection surface at the speckle reduction frequency.

16. A method of operating a laser projection system comprising a light source comprising at least one laser, a speckle reduction adjustable optical component and a scanning adjustable optical component, the method comprising:
generating at least a portion of a scanned laser image on a projection surface by operating the laser for optical emission of encoded image data and controlling the scanning adjustable optical component to rotate about at least two axes to scan an output beam emitted by the laser across a plurality of image pixels forming an image frame; and
rotating the speckle reduction adjustable optical component about a speckle reduction axis at a speckle reduction frequency to shift a position of the output beam upon the scanning adjustable optical component and illuminate common portions of successive image frames at a different angle of incidence on the projection surface as the plurality of image pixels are scanned across the projection surface.

17. The method as claimed in claim 16 further comprising compensating for a relative image shift on the projection surface resulting from the shifting position of the output beam upon the scanning adjustable optical component.

18. The method as claimed in claim 17 wherein compensating for the relative image shift on the projection surface further comprises applying an image compensation algorithm to alter the encoded image data in accordance with a distance of the laser projection system from the projection surface.

19. The method as claimed in claim 17 wherein compensating for the relative image shift on the projection surface further comprises rotating the scanning adjustable optical component about one of the at least two axes such that the output beam illuminates the same location on the projection surface for common portions of successive image frames.

20. The method as claimed in claim 10 wherein the scanning adjustable optical component comprises a MEMS-actuated mirror having a plurality of facets, each facet is angled to reflect the output beam toward the projection surface such that the output beam illuminates the same location on the projection surface for common portions of successive image frames as the speckle reduction adjustable optical component rotates about the speckle reduction axis.
